(19) United States
(12) Patent Application Publication
(10) Pub. No.: US 2014/0338145 A1
(43) Pub. Date: Nov. 20, 2014

(54) CONNECTING STRUCTURE OF WIPER ARM

(71) Applicant: KCW Corporation, Daegu (KR)

(72) Inventor: Ji Yong JUNG, Daegu (KR)

(73) Assignee: KCW Corporation, Daegu (KR)

(21) Appl. No.: 14/276,965

(22) Filed: May 13, 2014

(30) Foreign Application Priority Data
May 14, 2013 (KR) 10-2013-0054545

(51) Int. Cl. B60S 1/34

(52) U.S. Cl. CPC B60S 1/3488
USPC 15/250.34

(57) ABSTRACT

A connecting structure of a wiper arm may be provided according to an embodiment of the present invention, which includes: an arm head of which one side has an assembly hole and the other side has a first connecting portion; a retainer including a second connecting portion which is formed on one side thereof and is connected with the first connecting portion; and an elastic member connected between the arm head and the retainer.

### CROSS-REFERENCE TO RELATED APPLICATIONS

The present application claims priority under 35 U.S.C. §119(a) to Korean Patent Application No. 10-2013-0054545, filed on May 14, 2013, which is incorporated by reference herein in its entirety.

### BACKGROUND

1. Field

The present invention relates to a connecting structure of a wiper arm, and more particularly to a connecting structure of a wiper arm, connecting an arm head to a retainer, which form the joint of the wiper.

2. Description of Related Art

In general, a wiper of a vehicle includes a front wiper and a rear wiper. The front wiper is operated on the windshield in order to ensure the front visibility under the poor visibility caused by rain, snow, muddy water, or the like. The rear wiper is installed on the rear windshield of the vehicle so as to ensure the rear visibility.

While the front wiper is required to always operate whenever it is snowy, rainy, etc., the rear wiper is selectively operated only when there is a need for looking at the rear of the vehicle.

A connecting structure of the wiper which interconnects an arm head and retainer of the wiper is taken as an example of such a connecting structure of the wiper as disclosed in the patent document of the prior art.

Specifically, FIGS. 1 and 2 show that a conventional connecting structure of the wiper arm is obtained by inserting a pin or rivet 3 into both a through-hole 1a of an arm head 1 and a through-hole 2a of a retainer 2, and then by pressing and riveting an end of the through rivet 3. However, if a defect of the inserted pin or rivet occurs in the conventional connecting structure of the wiper arm, the connection durability between the arm head 1 and the retainer 2 is deteriorated.

Also, since the arm head 1 and the retainer 2 are connected to each other by directly inserting the pin or rivet into the through-hole la of the arm head 1 and the through-hole 2a of the retainer 2, the connecting process is not simple.

### SUMMARY

One embodiment is a connecting structure of a wiper arm. The connecting structure includes: an arm head including a first connecting portion on one side thereof; a retainer including a second connecting portion which is formed on one side thereof and is connected with the first connecting portion; and an elastic member connected between the arm head and the retainer. Any one of the first connecting portion and the second connecting portion includes a connecting protrusion and the other includes a connecting recess.

The first connecting portion includes a first catching part on which the other end of the elastic member is hung. The second connecting portion includes a second catching part on which the other end of the elastic member is hung.

The first catching part is a catching rod or a catching protrusion. The second catching part is a catching rod or a catching protrusion.

The connecting recess is comprised of a linear groove-shaped guide recess and a catching recess. The guide recess is formed in the linear groove open in any one of upward, lateral and downward directions in accordance with the direction in which the connecting protrusion is inserted.

The connecting recess is provided to have a groove with a circular cross section.

The connecting protrusion is provided to have any one of a column shape with a circular cross section of which one side has been cut, a column shape with an elliptical cross section, a column shape with a circular cross section, and a column shape with a circular cross section of which one side has been tapered.

The connecting protrusion has a width less than that of the connecting recess.

The connecting protrusion is made by a double injection method.

The connecting protrusion is made of a metallic material.

The elastic member is a spring.

The first connecting portion comprises an insertion portion, the connecting recess which is formed in one inner side or both inner sides of the insertion portion, and a first catching part on which one end of the elastic member is hung. The second connecting portion comprises a connection end, the connecting protrusion formed to protrude from one outer side or both outer sides of the connection end, and a second catching part on which the other end of the elastic member is hung. The connection end is inserted into the insertion portion, and the connecting protrusion is inserted into the connecting recess.

The first connecting portion comprises a connection end, the connecting protrusion formed to protrude from one outer side or both outer sides of the connection end; and a first catching part on which one end of the elastic member is hung. The second connecting portion comprises an insertion portion, the connecting recess which is formed in one inner side or both inner sides of the insertion portion, and a second catching part on which the other end of the elastic member is hung. The connection end is inserted into the insertion portion, and the connecting protrusion is inserted into the connecting recess.

The first connecting portion comprises an insertion portion, the connecting protrusion which is formed to protrude from one inner side or both inner sides of the insertion portion, and a first catching part on which one end of the elastic member is hung. The second connecting portion comprises a connection end, the connecting recess formed in one outer side or both outer sides of the connection end; and a second catching part on which the other end of the elastic member is hung. The connection end is inserted into the insertion portion, and the connecting protrusion is inserted into the connecting recess.

The first connecting portion comprises a connection end, the connecting recess formed in one outer side or both outer sides of the connection end; and a first catching part on which one end of the elastic member is hung. The second connecting portion comprises an insertion portion, the connecting protrusion which is formed to protrude from one inner side or both inner sides of the insertion portion, and a second catching part on which the other end of the elastic member is hung. The connection end is inserted into the insertion portion, and the connecting protrusion is inserted into the connecting recess.

The features and advantages of the present invention will be more apparent from the following detailed description based on the accompanying drawings.

Before the detailed description, it should be noted that the terms and words used in the present specification and the claims are not to be limited to their conventional and lexical meanings, but are to be interpreted to conform with the technical idea of the present invention under the principle that the inventor can properly define the terms for the best description of the invention made by the inventor.

### BRIEF DESCRIPTION OF THE DRAWINGS

FIG. 1 is a perspective view showing a conventional connecting structure of a wiper arm;

FIG. 2 is an exploded perspective view of the wiper arm shown in FIG. 1;

FIG. 3 is an exploded perspective view of the wiper arm for describing the connecting structure of the wiper arm according to a first embodiment of the present invention;

FIG. 4 is a perspective view showing that the wiper arm according to the first embodiment of the present invention has been connected;

FIG. 5a is a cross sectional view showing that the wiper arm according to the first embodiment of the present invention has been connected;

FIG. 5b is a perspective plan view enlarging the connecting structure of the connected wiper arm according to the first embodiment of the present invention;

FIGS. 6a-6c is a cross sectional view of an arm head for describing a connecting recess of the wiper arm according to the first embodiment of the present invention;

FIGS. 7a-7b is a sectional perspective view of the wiper arm for describing a lock-back state of the wiper arm according to the first embodiment of the present invention;

FIG. 8 is an exploded perspective view of the wiper arm for describing the connecting structure of the wiper arm according to a second embodiment of the present invention;

FIG. 9 is an exploded perspective view of the wiper arm for describing the connecting structure of the wiper arm according to a third embodiment of the present invention;

FIG. 10 shows an enlarged view of the connecting structure of the wiper arm according to a fourth embodiment of the present invention; and

FIG. 11 shows an enlarged view of the connecting structure of the wiper arm according to a fifth embodiment of the present invention.

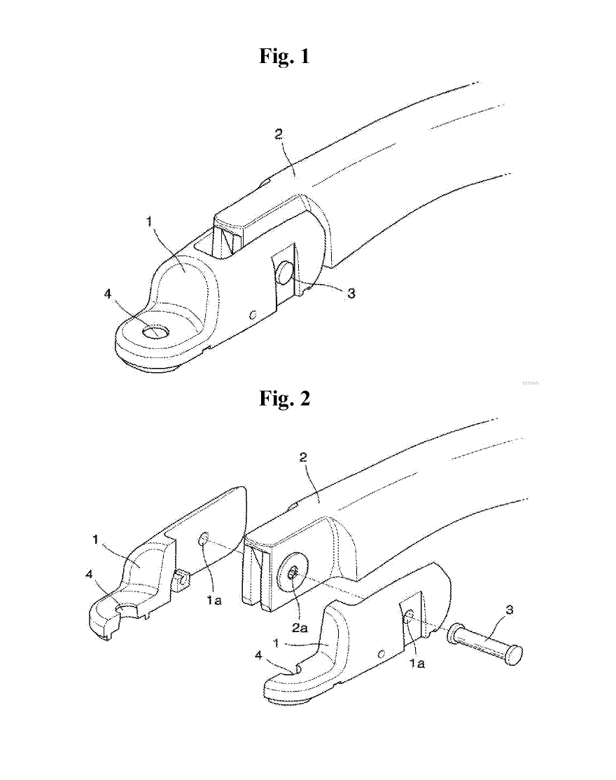

### DETAILED DESCRIPTION

The objects, particular advantages and novel features of the present invention will be more apparent from the following descriptions and exemplary embodiments which are related to the accompanying drawings. In the drawings, the same or similar elements are denoted by the same reference numerals even though they are depicted in different drawings. While terms such as the first and the second, etc., can be used to describe various components, the components are not limited by the terms mentioned above. The terms are used only for distinguishing between one component and other components. Throughout the description of the present invention, the detailed description of known technologies incorporated herein will be omitted when it may make the subject matter of the present invention unclear.

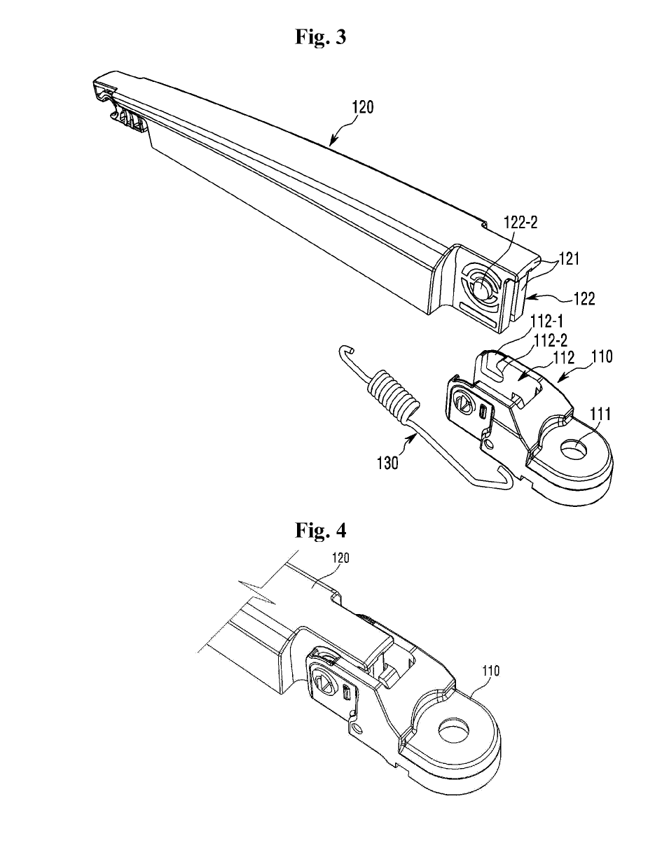

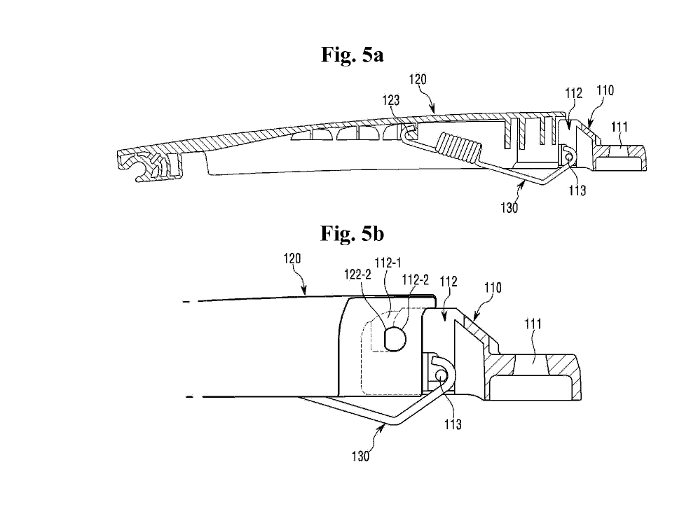

Hereafter, the exemplary embodiment of the present invention will be described with reference with the accompanying drawings. FIG. 3 is an exploded perspective view of the wiper arm for describing the connecting structure of the wiper arm according to a first embodiment of the present invention. FIG. 4 is a perspective view showing that the wiper arm according to the first embodiment of the present invention has been connected. FIG. 5 is a cross sectional view showing that the wiper arm according to the first embodiment of the present invention has been connected. FIG. 5b is a perspective plan view enlarging the connecting structure of the connected wiper arm according to the first embodiment of the present invention.

The connecting structure of the wiper arm according to the first embodiment of the present invention directly connects an arm head 110 with a retainer 120, which form the joint of the wiper. The connecting structure has an elastic restoring force by connecting an elastic member like a spring 130 between the arm head 110 and the retainer 120.

An assembly hole 111 in which a shaft (not shown) is installed is formed on one side of the arm head 110. An insertion portion 112 into which a connection end 122 of the retainer 120 is inserted is formed on the other side of the arm head 110.

Particularly, the insertion portion 112 includes a connecting recess which is comprised of a linear groove-shaped guide recess 112-1 and a catching recess 112-2 and is formed in one inner side or both inner sides of the insertion portion 112, and a catching rod 113 as a first catching part on which one end of the spring 130 is hung. Although the catching rod 113 as the first catching part is shown in the form of a rod within the insertion portion 112 in FIG. 5a, the catching rod 113 can be formed in the form of a catching protrusion without being limited to this.

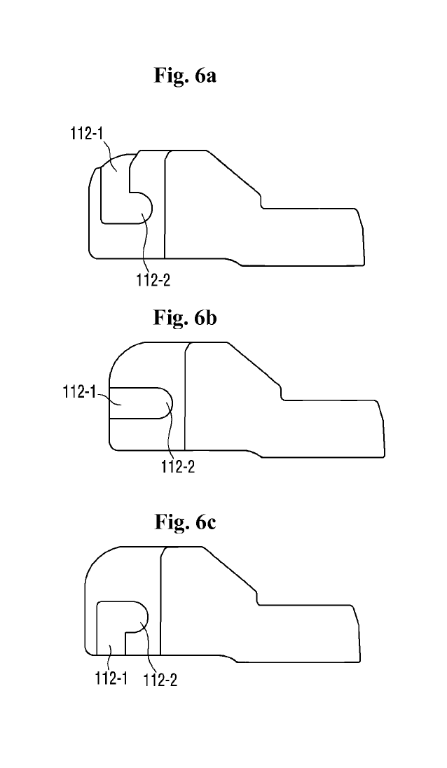

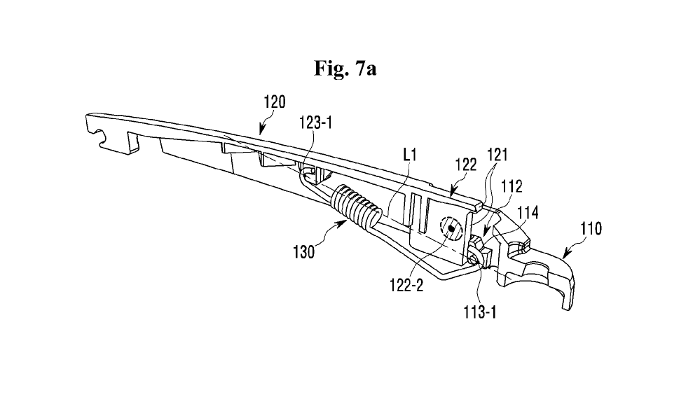

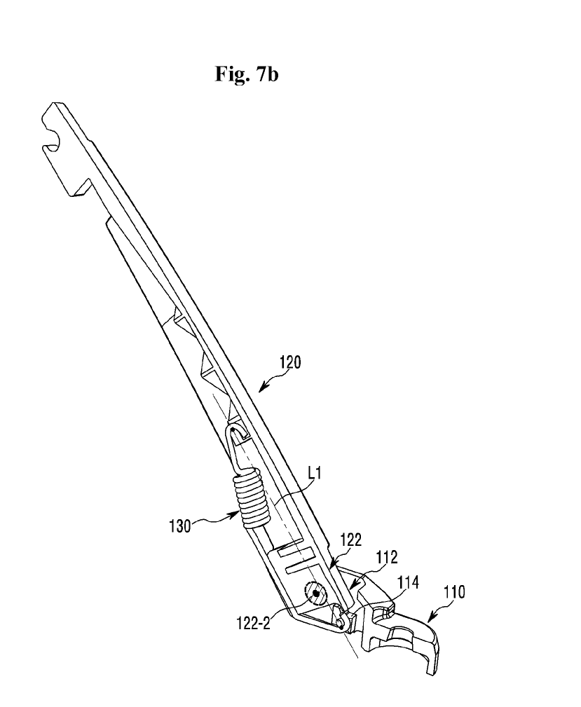

FIG. 6 is a cross sectional view of the arm head for describing a connecting recess of the wiper arm according to the first embodiment of the present invention. FIG. 7 is a sectional perspective view of the wiper arm for describing a lock-back state of the wiper arm according to the first embodiment of the present invention. The guide recess 112-1 is shown, as shown in FIG. 6a, in the form of a linear groove open toward the top of the arm head 110. However, there is no limit to this, and the guide recess 112-1 may be formed, as shown in FIGS. 6b and 6c, in the form of a linear groove open toward the side or bottom of the arm head 110 in accordance with the direction in which the connection end 122 of the retainer 120 is inserted. That is, according to another embodiment of the present invention, depending on the direction in which the connection end 122 of the retainer 120 is inserted into the insertion portion 112, the guide recess 112-1 may be formed in the form of the linear groove open toward the side or bottom of the arm head 110 within the insertion portion 112.

The retainer 120 may include the connection end 122 inserted into the insertion portion 112 of the arm head 110, a connecting protrusion 122-2 formed to protrude from one outer side or both outer sides of the connection end 122, and a catching protrusion 123 as a second catching part on which the other end of the spring 130 is hung. The catching protrusion 123 as the second catching part may be formed within the retainer 120 in FIG. 5 or may be formed in the form of the catching rod other than the catching protrusion.

The connecting protrusion 122-2 may be formed to have a column shape with an approximate circular cross section having a diameter less than the width of the guide recess 112-1 and the width of the catching recess 112-2 in such a manner as to reach the catching recess 112-2 via the guide recess 112-1 and to be hung on the catching recess 112-2. In the first embodiment of the present invention, the connecting protrusion 122-2 may be formed, as shown in FIG. 5b, to have a shape with a circular cross section of which one side has been cut. Therefore, the cut portion is guided along the guide recess 112-1 and inserted into the catching recess 112-2, so that the connecting protrusion 122-2 can be easily inserted into the catching recess 112-2.

Also, the connecting protrusion 122-2 is not limited to have the shape with a circular cross section of which one side has been cut. For example, the connecting protrusion 122-2 may have a column shape with an elliptical or circular cross section.

The connecting protrusion 122-2 may be manufactured by a double injection method, e.g., an insert injection process. When the metal-made connecting protrusion 122-2 is formed through the double injection method, the rigidity of the connecting protrusion can be improved. Also, even when the metal-made connecting protrusion 122-2 is formed by another method instead of the double injection method, the rigidity of the connecting protrusion can be improved.

As shown in FIG. 5b, the connecting protrusion 122-2 reaches and is inserted into the catching recess 112-2. Here, the connecting protrusion 122-2 may be inserted rotatably with respect to the catching recess 112-2.

The spring 130 is an elastic member. The ends of the spring 130 is supported by the catching rod 113 of the arm head 110 and the catching protrusion 123 of the retainer 120 respectively, so that the spring 130 has an elastic restoring force in a direction in which the arm head 110 and the retainer 120 get closer to each other. Here, in addition to the spring 130, an elastic member, for example, a rubber band, an elastic cord, etc., may be used as the spring.

Since the spring 130 is supported inwardly by the catching rod 113 of the arm head 110 and the catching protrusion 123 of the retainer 120, the catching rod 113 and the catching protrusion 123 are not exposed outward and then can be prevented from being damaged. Also, spring 130 provides an elastic tensile strength, thereby more securely connecting the arm head 110 with the retainer 120.

Under the state where the connecting protrusion 122-2 has been connected, as shown in FIG. 7a, to the catching recess 112-2 by inserting the connection end 122 into the insertion portion 112 (hereafter, referred to as an initial state), when a user performs a relative rotation on the retainer 120 with respect to the arm head 110 in a farther direction from the glass of a vehicle for the purpose of replacement of the blade, the retainer 120 rotates about the center of the connecting protrusion 122-2 by an external force. When the external force is removed during the relative rotation, the retainer 120 is restored to the initial state by the elastic restoring force of the spring 130. If the retainer 120 is, as shown in FIG. 7b, rotated by the sufficient external force and then a straight line L1 connecting a contact point 113-1 between the spring 130 and the catching rod 113 with a contact point 123-1 between the spring 130 and the catching protrusion 123 passes beyond the center of the connecting protrusion 122-2, the elastic restoring force of the spring 130 applied below the center of the connecting protrusion 122-2 in the initial state is applied above the center of the connecting protrusion 122-2. Here, the end surface 121 of the connection end 122 is supported by contacting with a support surface 114 within the insertion portion 112, so that even though the applied external force is removed, the retainer 120 becomes a stationary state (hereafter, referred to as a lock-back state) with being relatively rotated with respect to the arm head 110.

In the above-mentioned connecting structure of the wiper arm according to the first embodiment of the present invention, the arm head 110 is fixed to a shaft installed in the frame of the vehicle through the assembly hole 111 and is also rotated by the rotation of the shaft. Here, the retainer 120 is connected to the arm head 110 and transfers the rotation force of the arm head 110 to a blade (not shown) coupled rotatably to the other end of the retainer 120.

Here, in the connecting structure of the wiper arm according to the first embodiment of the present invention, the connection portion between the arm head 110 and the retainer 120 is covered with a cap (not shown), thereby protecting the connecting portion or enhancing the aesthetic features.

The connecting structure of the wiper arm according to the first embodiment of the present invention is characterized in easily connecting the arm head 110 with the retainer 120 by using the connecting protrusion 122-2 without the existing pin or rivet.

Accordingly, through the connecting structure of the wiper arm according to the first embodiment of the present invention, it is possible to reduce the production cost in that the arm head 110 and the retainer 120 are connected with each other without the existing pin or rivet and to simplify the assembly process in that the arm head 110 and the retainer 120 are easily connected with each other by using the connecting protrusion 122-2.

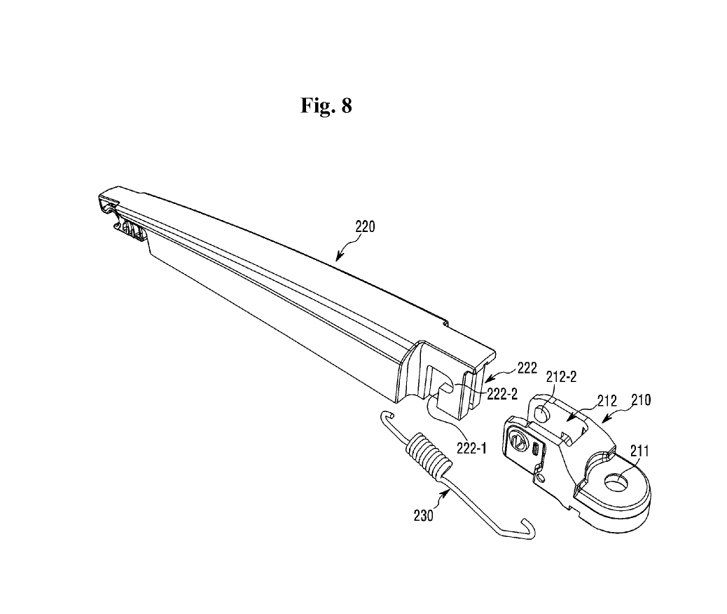

Hereafter, a connecting structure of the wiper arm according to a second embodiment of the present invention will be described with reference to FIG. 8. FIG. 8 is an exploded perspective view of the wiper arm for describing the connecting structure of the wiper arm according to the second embodiment of the present invention.

The connecting structure of the wiper arm according to the second embodiment of the present invention shown in FIG. 8 is different from the connecting structure of the wiper arm according to the first embodiment of the present invention shown in FIG. 3. The difference is that an arm head 210 includes an insertion portion 212 including a connecting protrusion 212-2, and a connecting end 222 of a retainer 220 includes a connecting recess comprised of a linear groove-shaped guide recess 222-1 and a catching recess 222-2, and then the arm head 310 and the retainer 320 are connected with each other.

Specifically, the arm head 210 includes the insertion portion 212 including the connecting protrusion 212-2 formed on one inner side or both inner sides of the insertion portion 212, and then the connection end 222 of the retainer 220 is inserted and connected to the insertion portion 212.

The connecting protrusion 212-2 may be formed to have a column shape with an approximate circular cross section having a diameter less than the width of the guide recess 222-1 and the width of the catching recess 222-2 in such a manner as to reach the catching recess 222-2 via the guide recess 222-1 and to be hung on the catching recess 222-2. For example, the connecting protrusion 212-2 may be formed to have a shape with a circular cross section of which one side has been cut. Then, the cut portion is guided along the guide recess 222-1 and inserted into the catching recess 222-2, so that the connecting protrusion 212-2 can be easily inserted into the catching recess 222-2. Also, the connecting protrusion 212-2 is not limited to have the shape with a circular cross section of which one side has been cut. For example, the connecting protrusion 212-2 may have a column shape with an elliptical or circular cross section.

The connecting protrusion 212-2 may be manufactured by a double injection method, e.g., an insert injection process. When the metal-made connecting protrusion 212-2 is formed through the double injection method, the rigidity of the connecting protrusion can be improved. Also, even when the metal-made connecting protrusion 212-2 is formed by another method instead of the double injection method, the rigidity of the connecting protrusion can be improved.

The retainer 220 includes the connection end 222 including the connecting recess which is comprised of the linear groove-shaped guide recess 222-1 and the catching recess 222-2 and is formed in one outer side or both outer sides of the connection end 222.

Particularly, the guide recess 222-1 is formed in the form of a linear groove open toward the bottom of the connection end 222, so that the connecting protrusion 212-2 is easily guided along the guide recess 222-1 and reaches the catching recess 222-2 during the process of inserting downwardly the connection end 222 into the insertion portion 212. Additionally, depending on the direction in which the connection end 222 is inserted into the insertion portion 212, the guide recess 222-1 is formed in the outer surface of the connection end 222 in the form of a linear groove open selectively toward the side or top of the connection end 222 as well as toward the bottom of the connection end 222. Thus, it is possible to ensure the convenience in the assembly process.

In the above-mentioned connecting structure of the wiper arm according to the second embodiment of the present invention, without the existing pin or rivet, the insertion portion 212 of the arm head 210, which includes the connecting protrusion 212-2, is directly connected with the connection end 222 of the retainer 220 including the connecting recess comprised of the linear groove-shaped guide recess 222-1 and the catching recess 222-2, so that it is possible to ensure the convenience in the assembly process.

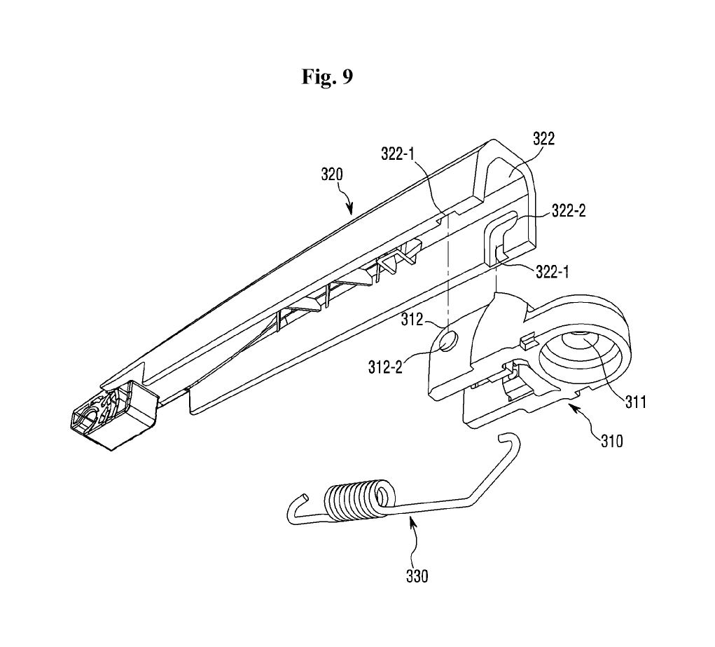

Hereafter, a connecting structure of the wiper arm according to a third embodiment of the present invention will be described with reference to FIG. 9. FIG. 9 is an exploded perspective view of the wiper arm for describing the connecting structure of the wiper arm according to the third embodiment of the present invention. Here, in the description of the connecting structure of the wiper arm according to the third embodiment of the present invention, the same parts as those of the connecting structure of the wiper arm according to the first embodiment of the present invention will be omitted.

The connecting structure of the wiper arm according to the third embodiment of the present invention shown in FIG. 9 is different from the connecting structure of the wiper arm according to the first embodiment of the present invention shown in FIG. 3. The difference is that an arm head 310 includes a connection end 312 including a connecting protrusion 312-2, and a retainer 320 includes an insertion portion 322 including a connecting recess comprised of a line groove-shaped guide recess 322-1 and a catching recess 322-2, and then the arm head 210 and the retainer 220 are connected with each other.

Specifically, the arm head 310 includes the connection end 312 including the connecting protrusion 312-2 formed on one outer side or both outer sides of the connection end 312 on an opposite side to an assembly hole 311. Then, the connection end 312 of the arm head 310 is inserted and connected to the insertion portion 322 of the retainer 320.

The connecting protrusion 312-2 may be formed to have a column shape with an approximate circular cross section having a diameter less than the width of the guide recess 322-1 and the width of the catching recess 322-2 in such a manner as to reach the catching recess 322-2 via the guide recess 322-1 and to be hung on the catching recess 322-2. For example, the connecting protrusion 312-2 may be formed to have a shape with a circular cross section of which one side has been cut. Then, the cut portion is guided along the guide recess 322-1 and inserted into the catching recess 322-2, so that the connecting protrusion 312-2 can be easily inserted into the catching recess 322-2. Also, the connecting protrusion 312-2 is not limited to have the shape with a circular cross section of which one side has been cut. For example, the connecting protrusion 312-2 may have a column shape with an elliptical or circular cross section.

The connecting protrusion 312-2 may be manufactured by a double injection method, e.g., an insert injection process. When the metal-made connecting protrusion 312-2 is formed through the double injection method, the rigidity of the connecting protrusion can be improved. Also, even when the metal-made connecting protrusion 312-2 is formed by another method instead of the double injection method, the rigidity of the connecting protrusion can be improved.

The retainer 320 includes the insertion portion 322 including the connecting recess which is comprised of the linear groove-shaped guide recess 322-1 and the catching recess 322-2 and is formed in one outer side or both outer sides of the retainer 320.

Also, the guide recess 322-1 included in the insertion portion 322 is formed in the form of a linear groove open toward the bottom of the retainer 320, so that the connecting protrusion 312-2 is easily guided along the guide recess 322-1 and reaches the catching recess 322-2 during the process of inserting upwardly the connection end 312 into the insertion portion 322. Additionally, depending on the direction in which the connection end 312 is inserted into the insertion portion 322, the guide recess 322-1 is formed in the form of a linear groove open selectively toward the side or top of the retainer 320 as well as toward the bottom of the retainer 320. Thus, it is possible to ensure the convenience in the assembly process.

In the above-mentioned connecting structure of the wiper arm according to the third embodiment of the present invention, the connection end 312 of the arm head 310, which includes the connecting protrusion 312-2, is inserted and connected to the insertion portion 322 including the linear groove-shaped guide recess 322-1 and the catching recess 322-2 which are formed in one inner side or both inner sides of the insertion portion 322, so that the arm head 310 and the retainer 320 are connected with each other. Therefore, it is possible to ensure the convenience in the assembly process.

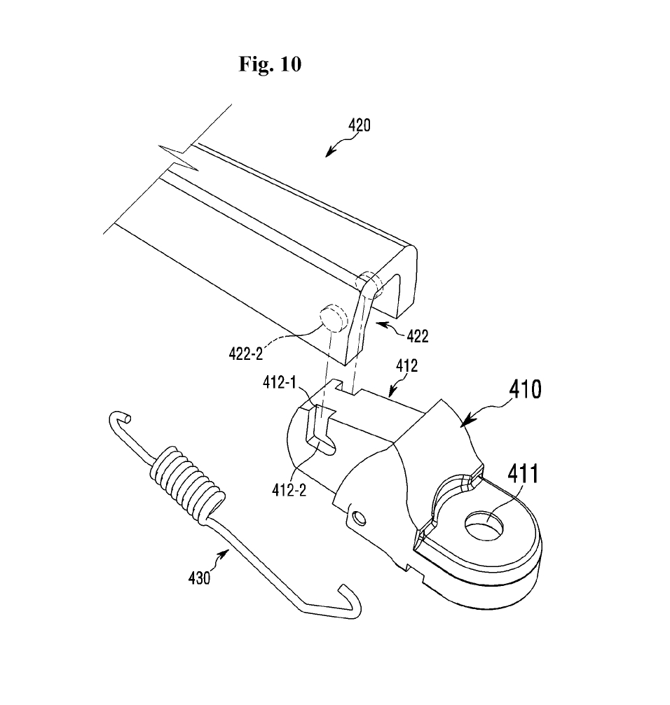

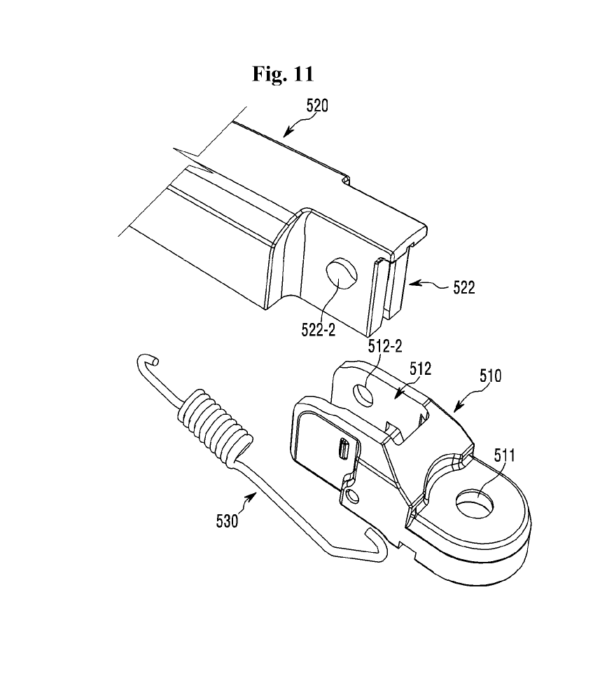

Hereafter, a connecting structure of the wiper arm according to a fourth embodiment of the present invention will be described with reference to FIG. 10. FIG. 10 shows an enlarged view of the connecting structure of the wiper arm according to the fourth embodiment of the present invention. Here, in the description of the connecting structure of the wiper arm according to the fourth embodiment of the present invention, the same parts as those of the connecting structure of the wiper arm according to the first embodiment of the present invention will be omitted.

The connecting structure of the wiper arm according to the fourth embodiment of the present invention shown in FIG. 10 is different from the connecting structure of the wiper arm according to the first embodiment of the present invention shown in FIG. 3. The difference is that an arm head 410 includes a connection end 412 including a linear groove-shaped guide recess 412-1 and a catching recess 412-2, and a retainer 420 includes an insertion portion 422 in which a connecting protrusion 422-2 is formed, and then the arm head 410 and the retainer 420 are connected with each other.

Specifically, the arm head 410 includes the connection end 412 including the linear groove-shaped guide recess 412-1 and the catching recess 412-2 which are formed in one outer side or both outer sides of the connection end 412 on an opposite side to an assembly hole 411. Then, the connection end 412 of the arm head 410 is inserted and connected to the insertion portion 422 of the retainer 420.

The connecting protrusion 422-2 may be formed to have a column shape with an approximate circular cross section having a diameter less than the width of the guide recess 412-1 and the width of the catching recess 412-2 in such a manner as to reach the catching recess 412-2 via the guide recess 412-1 and to be hung on the catching recess 412-2. For example, the connecting protrusion 422-2 may be formed to have a shape with a circular cross section of which one side has been cut. Then, the cut portion is guided along the guide recess 412-1 and inserted into the catching recess 412-2, so that the connecting protrusion 422-2 can be easily inserted into the catching recess 412-2. Also, the connecting protrusion 422-2 is not limited to have the shape with a circular cross section of which one side has been cut. For example, the connecting protrusion 422-2 may have a column shape with an elliptical or circular cross section.

The connecting protrusion 422-2 may be manufactured by a double injection method, e.g., an insert injection process. When the metal-made connecting protrusion 422-2 is formed through the double injection method, the rigidity of the connecting protrusion can be improved. Also, even when the metal-made connecting protrusion 422-2 is formed by another method instead of the double injection method, the rigidity of the connecting protrusion can be improved.

The retainer 420 includes the insertion portion 422 including the connecting protrusion 422-2 formed on one inner side or both inner sides of the insertion portion 422.

Also, the guide recess 412-1 included in the connection end 412 is formed in the form of a linear groove open toward the top of the arm head 410, so that the connecting protrusion 422-2 is easily guided along the guide recess 412-1 and reaches the catching recess 412-2 during the process of inserting upwardly the connection end 412 into the insertion portion 422. Additionally, depending on the direction in which the connection end 412 is inserted into the insertion portion 422, the guide recess 412-1 is formed in the form of a linear groove open selectively toward the side or bottom of the retainer 420 as well as toward the top of the retainer 420. Thus, it is possible to ensure the convenience in the assembly process.

In the above-mentioned connecting structure of the wiper arm according to the fourth embodiment of the present invention, the connection end 412 of the arm head 410, which includes the linear groove-shaped guide recess 412-1 and the catching recess 412-2, is inserted and connected to the insertion portion 422 including the connecting protrusion 422-2 formed on one inner side or both inner sides of the insertion portion 422, so that the arm head 410 and the retainer 420 are connected with each other. Therefore, it is possible to ensure the convenience in the assembly process.

Hereafter, a connecting structure of the wiper arm according to a fifth embodiment of the present invention will be described with reference to FIG. 11. FIG. 11 shows an enlarged view of the connecting structure of the wiper arm according to the fifth embodiment of the present invention. Here, in the description of the connecting structure of the wiper arm according to the fifth embodiment of the present invention, the same parts as those of the connecting structure of the wiper arm according to the first embodiment of the present invention will be omitted.

The connecting structure of the wiper arm according to the fifth embodiment of the present invention directly connects the arm head with the retainer. The connecting structure has an elastic restoring force by connecting an elastic member like a spring 530 between an arm head 510 and a retainer 520.

The connecting structure of the wiper arm according to the fifth embodiment of the present invention is characterized in that a connecting protrusion 522-2 formed on both sides of a connecting end 522 of the retainer is in direct contact with and pivotably connected to both catching recesses 512-2 formed in an insertion portion 512 of the arm head 510.

Specifically, the connecting protrusion 522-2 may be formed to have one side that is tapered in the connection direction so as to be more easily connected to the catching recess 512-2, that is to say, the top surface of the cylindrical connecting protrusion 522-2 may be inclined such that the height of the connecting protrusion 522-2 is gradually reduced.

The connecting protrusion 522-2 may be manufactured by a double injection method, e.g., an insert injection process. When the metal-made connecting protrusion 522-2 is formed through the double injection method, the rigidity of the connecting protrusion can be improved. Also, even when the metal-made connecting protrusion 522-2 is formed by another method instead of the double injection method, the rigidity of the connecting protrusion can be improved.

The catching recess 512-2 has a circular shape with a diameter larger than that of the connecting protrusion 522-2 and is formed in both inner sides of the insertion portion 512 respectively.

Here, since the connecting protrusion 522-2 has a shape which is tapered in one direction and is cylindrical in the other directions, the connecting protrusion 522-2 may be in contact with in a sliding manner and pivotably connected to the catching recess 512-2.

Additionally, on the contrary to the structure in which the connecting protrusion 522-2 and the catching recess 512-2 are included in the connection end 522 and the insertion portion 512 respectively, the arm through the structure in which the connecting protrusion 522-2 and the catching recess 512-2 are included in the insertion portion 512 and the connection end 522 respectively, so that the arm head 510 and the retainer 520 can be connected with each other.

Also, optionally, on the contrary to the structure in which the arm head 510 and the retainer 520 include the insertion portion 512 and the connection end 522 respectively, so that the arm head 510 and the retainer 520 are connected with each other, the arm head 510 and the retainer 520 include the connection end 522 and the insertion portion 512 respectively, so that the arm head 510 and the retainer 520 may be connected with each other.

In the above-mentioned connecting structure of the wiper arm according to the fifth embodiment of the present invention, the connecting protrusion 522-2 tapered in one direction is more easily connected to the catching recess 512-2 without the existing pin or rivet, and the connecting protrusion 522-2 which is cylindrical in the other directions can be pivoted on the catching recess 512-2.

Accordingly, through the connecting structure of the wiper arm according to the fifth embodiment of the present invention, it is possible to reduce the production cost in that the arm head 510 and the retainer 520 are connected with each other without the existing pin or rivet and to simplify the assembly process in that the arm head 510 and the retainer 520 are more easily connected with each other by using the tapered connecting protrusion 522-2.

The spirit of the present invention has been described in detail according to the exemplary embodiment. It should be noted that the above-described embodiments are not intended for limiting the spirit but intended for describing the spirit.

Further, it can be understood by those of ordinary skill in the art of the present invention that various embodiments are allowed within the range of the spirit of the present invention.

What is claimed is:

1. A connecting structure of a wiper arm, the connecting structure comprising:
an arm head comprising a first connecting portion on one side thereof;
a retainer comprising a second connecting portion which is formed on one side thereof and is connected with the first connecting portion; and
an elastic member connected between the arm head and the retainer,
wherein any one of the first connecting portion and the second connecting portion comprises a connecting protrusion and the other comprises a connecting recess.

2. The connecting structure of the wiper arm of claim 1,
wherein the first connecting portion comprises a first catching part on which one end of the elastic member is hung,
and wherein the second connecting portion comprises a second catching part on which the other end of the elastic member is hung.

3. The connecting structure of the wiper arm of claim 2,
wherein the first catching part is a catching rod or a catching protrusion,
and wherein the second catching part is a catching rod or a catching protrusion.

4. The connecting structure of the wiper arm of claim 1, wherein the connecting recess is comprised of a linear groove-shaped guide recess and a catching recess, and wherein the guide recess is formed in the form of a linear groove open in any one of upward, lateral and downward directions in accordance with the direction in which the connecting protrusion is inserted.

5. The connecting structure of the wiper arm of claim 1, wherein the connecting recess is provided to have a groove with a circular cross section.

6. The connecting structure of the wiper arm of claim 1, wherein the connecting protrusion is provided to have any one of a column shape with a circular cross section of which one side has been cut, a column shape with an elliptical cross section, a column shape with a circular cross section, and a column shape with a circular cross section of which one side has been tapered.

7. The connecting structure of the wiper arm of claim 1, wherein the connecting protrusion has a width less than that of the connecting recess.

8. The connecting structure of the wiper arm of claim 1, wherein the connecting protrusion is made by a double injection method.

9. The connecting structure of the wiper arm of claim 1, wherein the connecting protrusion is made of a metallic material.

10. The connecting structure of the wiper arm of claim 1, wherein the elastic member is a spring.

11. The connecting structure of the wiper arm of claim 1,
wherein the first connecting portion comprises an insertion portion, the connecting recess which is formed in one inner side or both inner sides of the insertion portion, and a first catching part on which one end of the elastic member is hung,
wherein the second connecting portion comprises a connection end, the connecting protrusion formed to protrude from one outer side or both outer sides of the connection end, and a second catching part on which the other end of the elastic member is hung,
and wherein the connection end is inserted into the insertion portion, and the connecting protrusion is inserted into the connecting recess.

12. The connecting structure of the wiper arm of claim 1,
wherein the first connecting portion comprises a connection end, the connecting protrusion formed to protrude from one outer side or both outer sides of the connection end; and a first catching part on which one end of the elastic member is hung,
wherein the second connecting portion comprises an insertion portion, the connecting recess which is formed in one inner side or both inner sides of the insertion portion, and a second catching part on which the other end of the elastic member is hung, and
wherein the connection end is inserted into the insertion portion, and the connecting protrusion is inserted into the connecting recess.

13. The connecting structure of the wiper arm of claim 1,
wherein the first connecting portion comprises an insertion portion, the connecting protrusion which is formed to protrude from one inner side or both inner sides of the insertion portion, and a first catching part on which one end of the elastic member is hung,
wherein the second connecting portion comprises a connection end, the connecting recess formed in one outer side or both outer sides of the connection end; and a second catching part on which the other end of the elastic member is hung, and
wherein the connection end is inserted into the insertion portion, and the connecting protrusion is inserted into the connecting recess.

14. The connecting structure of the wiper arm of claim 1,
wherein the first connecting portion comprises a connection end, the connecting recess formed in one outer side or both outer sides of the connection end; and a first catching part on which one end of the elastic member is hung,
wherein the second connecting portion comprises an insertion portion, the connecting protrusion which is formed to protrude from one inner side or both inner sides of the insertion portion, and a second catching part on which the other end of the elastic member is hung, and
wherein the connection end is inserted into the insertion portion, and the connecting protrusion is inserted into the connecting recess.
